(19) United States
(12) Patent Application Publication
(10) Pub. No.: US 2026/0159226 A1
(43) Pub. Date: Jun. 11, 2026

(54) FORCE APPLICATION DEVICE FOR A CONTROL STICK, CONTROL STICK, METHOD, PROGRAM AND AIRCRAFT

(71) Applicant: SAFRAN ELECTRONICS & DEFENSE, Paris (FR)

(72) Inventor: Yannick Ghislain Sébastien Xavier ATTRAZIC, Moissy-Cramayel (FR)

(73) Assignee: SAFRAN ELECTRONICS & DEFENSE, Paris (FR)

(21) Appl. No.: 18/707,955

(22) PCT Filed: Nov. 4, 2022
(86) PCT No.: PCT/FR2022/052077

§ 371 Date: May 7, 2024

(30) Foreign Application Priority Data
Nov. 8, 2021 (FR) 2111825

(51) Int. Cl. B64C 13/04; B64C 13/18

(52) U.S. Cl. CPC B64C 13/0421; B64C 13/18

(57) ABSTRACT

The invention relates to a force application device for an aircraft control stick, in which the computer is configured: a) for an angle (ANG1) smaller than or equal to a prescribed virtual stop threshold (S1, S2), to control the motor so that it applies a resistive force (EFF1) to the lever, according to the angle (ANG1), and to deactivate the brake; b) for an angle (ANG1) which is increasing beyond the prescribed threshold (S1, S2), to control the motor and activate the brake so that they apply a resistive force (EFF2) to the lever that is higher than the value (V1); c for an angle (ANG1) which is decreasing while being higher than the prescribed virtual stop threshold (S1, S2), to control the motor so that it applies a return force (EFF3) to the lever according to the angle (ANG1) and to deactivate the brake.

The invention relates to a force application device for an aircraft control stick, an active aircraft control stick equipped with this device, a method of haptic feedback control of an aircraft control stick and a computer program for implementing the control method.

The field of the invention relates to the on-board control sticks of an aircraft, such as for example an airplane or a helicopter or another aircraft.

A force application device for an aircraft control stick is known from the document WO 2020/053534.

A goal of the invention is to be able to detect the intention of the pilot based on the control stick.

Devices usually implemented to detect the intention of an operator/pilot are force or torque sensors which supply force information.

Force information may be needed for the servocontrol of mechatronic/electromechanical systems. It can be used to develop servocontrols requiring data which can be used to minimize phase shifts in the control loops. Such information is generally used in automation to reduce the phase shifts usually observed in position sensors that have undergone digital processing and that are consequently phase-shifted. Force information can also be used to refine the regulation of the servo loops.

Since aircraft control mini-sticks are members fulfilling critical functions, the feared events of which are catastrophic (from an operational safety point of view), its entire architecture and constituent components must meet extremely stringent rules in terms of architecture (redundancy, dissimilarity etc.), development processes, robustness, etc.

The need for an item of information about the intention of the pilot and the use of a dedicated force sensor to fulfil this function requires the design of a system that is complex, redundant, voluminous and difficult to integrate. Such a device is thus very complex and costly by nature.

The addition of such a member also of necessity affects the general reliability of the equipment, increasing the number of constituent components in the system.

For all these reasons, the aim is to avoid the use of such a type of force sensor, while simplifying the mini-stick system.

The invention has the aim of obtaining a force application device for an aircraft control stick, an active aircraft control stick equipped with this device, a method of haptic feedback control of an aircraft control stick and a computer program for implementing the control method, which meet the above-mentioned goals.

For this purpose, a first subject matter of the invention is a force application device for an aircraft control stick, the device comprising:
a mechanical joint configured to receive an aircraft control stick lever, the mechanical joint being rotationally movable about at least one axis from among a roll axis and a pitch axis,
at least one force motor comprising at least one motor shaft extending along at least one direction of actuation, the rotation of the motor shaft about the direction of actuation being linked to the rotation of the mechanical joint about the axis, the force motor being configured to exert a resistive torque on the motor shaft,
at least one rheological brake, able to apply a resistive force to the motor shaft,
at least one sensor for measuring at least one angular position and at least one sign of the velocity about the axis and/or about the motor shaft,
a calculator for controlling the rheological brake and the force motor,
   characterized in that
      the calculator is configured to control the rheological brake and the force motor as a function of the angular position and of the sign of the velocity having been measured by the sensor, to:
a) when the angular position corresponds to an angle of the lever with respect to a prescribed neutral position, less than or equal in absolute value to a prescribed virtual stop threshold, control the motor to make it apply to the lever a first resistive force as a function of the angle of the lever and deactivate the brake, the first resistive force having a first determined value, which is non-zero at the prescribed virtual stop threshold,
b) when the angular position corresponds to an angle of the lever with respect to the prescribed neutral position, which increases in absolute value beyond the prescribed virtual stop threshold, control the motor and activate the brake to make them apply to the lever a second resistive force greater than the first value,
c) when the angular position corresponds to an angle of the lever with respect to the prescribed neutral position, which in absolute value decreases and is greater than the prescribed virtual stop threshold, control the motor to make it apply to the lever a third return force as a function of the angle of the lever and deactivate the brake.

The invention thus makes it possible to provide a virtual stop on the aircraft control stick, in the direction of increase of the angle of the lever of this stick.

Thus, in the case where the pilot increases the angle of the lever to above the virtual stop threshold, the brake is activated in order to produce an additional resistive force on the stick, which will be felt by the pilot (case b mentioned above). Thus, as long as the stick has an angle greater than the threshold and the pilot wishes to push on the stick in the aim of increasing this angle, the brake will be activated to oppose the displacement. The sensor for measuring the angular position and the sign of the velocity makes it possible to detect the intention of the pilot wishing to increase the angle of the lever in this case b).

Case c) corresponds to detection of the fact that the pilot wishes to see the stick return to the neutral position. In this case, the brake is deactivated to allow either the motor, or the hand of the user, to displace the lever into the neutral position. The sensor for measuring the angular position and the sign of the velocity makes it possible to detect the intention of the pilot wishing to reduce the angle of the lever in this case c).

According to an embodiment of the invention, the first resistive force increases as a function of the angle of the lever.

According to an embodiment of the invention, the second resistive force is equal to a resistive force plateau, which is constant as a function of the angle of the lever with respect to the prescribed neutral position, which increases beyond the prescribed virtual stop threshold.

According to an embodiment of the invention, the third return force increases as a function of the angle of the lever.

According to an embodiment of the invention, the second resistive force is greater than or equal to 1.5 times the first value.

According to an embodiment of the invention, the second resistive force is greater than or equal to 50 N and less than or equal to 200 N.

According to an embodiment of the invention, the prescribed virtual stop threshold is greater than or equal to 5° and less than or equal to 45°.

According to an embodiment of the invention, the third resistive force is equal to the first determined value, non-zero at the prescribed virtual stop threshold.

According to an embodiment of the invention, the rheological brake comprises a first part, a second part located facing the first part and a volume delimited by the first part and by the second part, the volume being suitable for containing a rheological material, the first part being arranged on the motor shaft and being rotationally movable about the direction of actuation with respect to the second part,
the device comprises a generator, which is configured to apply a variable magnetic field within the volume to vary a shear resistance of the rheological material and which is controlled by the calculator.

According to an embodiment of the invention, the calculator is configured to compute the angle of the lever with respect to the prescribed neutral position as a function of the angular position having been measured by the sensor.

According to an embodiment of the invention, the calculator is configured to compute a direction of increase or decrease of the angle of the lever as a function of the sign of the velocity having been measured by the sensor.

According to an embodiment of the invention, provision is made for the axis to be the roll axis and the pitch axis,
provision is made for the force motor to be a first force motor comprising a first motor shaft extending along at least a first direction of actuation and a second force motor comprising a second motor shaft extending along at least a second direction of actuation, the rotation of the first motor shaft about the first direction of actuation being linked to the rotation of the mechanical joint about the roll axis, the rotation of the second motor shaft about the second direction of actuation being linked to the rotation of the mechanical joint about the pitch axis,
the first force motor being configured to exert a resistive torque on the first motor shaft, the second force motor being configured to exert a resistive torque on the second motor shaft,
provision is made for the rheological brake to be a first rheological brake able to apply a resistive force to the first motor shaft and a second rheological brake, able to apply another resistive force to the second motor shaft,
provision is made for the measurement sensor to be a first sensor for measuring a first angular position and a sign of the velocity about the roll axis and/or about the first motor shaft, and a second sensor for measuring a second angular position and a sign of the velocity about the pitch axis and/or about the second motor shaft.

A second subject matter of the invention is an active aircraft control stick, comprising:
a force application device as described above,
a lever able to rotate about the at least one axis, the lever being arranged on the mechanical joint.

A third subject matter of the invention is a method of haptic feedback control of an aircraft control stick using the force application device as described above, a method in which a user exerts a tilt force on the stick, characterized in that in response to the tilt force exerted by the user on the stick, the sensor measures the at least one angular position and the at least one sign of the velocity about the at least one axis and/or about the at least one motor shaft and the calculator controls the rheological brake and the force motor as a function of the angular position and of the sign of the velocity having been measured by the sensor, to:
a) when the angular position corresponds to an angle of the lever with respect to a prescribed neutral position, less than or equal in absolute value to a prescribed virtual stop threshold, control the motor to make it apply to the lever a first resistive force as a function of the angle of the lever and deactivate the brake, the first resistive force having a first determined value, which is non-zero at the prescribed virtual stop threshold,
b) when the angular position corresponds to an angle of the lever with respect to the prescribed neutral position, which increases in absolute value beyond the prescribed virtual stop threshold, control the motor and activate the brake to make them apply to the lever a second resistive force greater than the first value,
c) when the angular position corresponds to an angle of the lever with respect to the prescribed neutral position, which in absolute value decreases and is greater than the prescribed virtual stop threshold, control the motor to make it apply to the lever a third return force as a function of the angle of the lever and deactivate the brake.

A fourth subject matter of the invention is a computer program for implementing the method of haptic feedback control of an aircraft control stick as described above, comprising code instructions, which, when they are executed on the control calculator, implement the following steps:
computing the angle of the lever with respect to the prescribed neutral position as a function of the angular position having been measured by the sensor,
computing a direction of increase or decrease of the angle of the lever as a function of the sign of the velocity having been measured by the sensor,
a) when the angle of the lever with respect to its prescribed neutral position is in absolute value less than or equal to the prescribed virtual stop threshold, controlling the motor to make it apply to the lever a first resistive force as a function of the angle of the lever and deactivating the brake, the first resistive force having a first determined value, which is non-zero at the prescribed virtual stop threshold,
b) when the angle of the lever with respect to its prescribed neutral position increases in absolute value beyond the prescribed virtual stop threshold, controlling the motor and activating the brake to make them apply to the lever a second resistive force greater than the first value,
c) when the angle of the lever with respect to its prescribed neutral position in absolute value decreases and is greater than the prescribed virtual stop threshold, controlling the motor to make it apply to the lever a third return force as a function of the angle of the lever and deactivating the brake.

A fifth subject matter of the invention is an aircraft comprising the active control stick as described above.

The invention will be better understood on reading the following description, given solely by way of non-limiting example with reference to the figures below of the appended drawings.

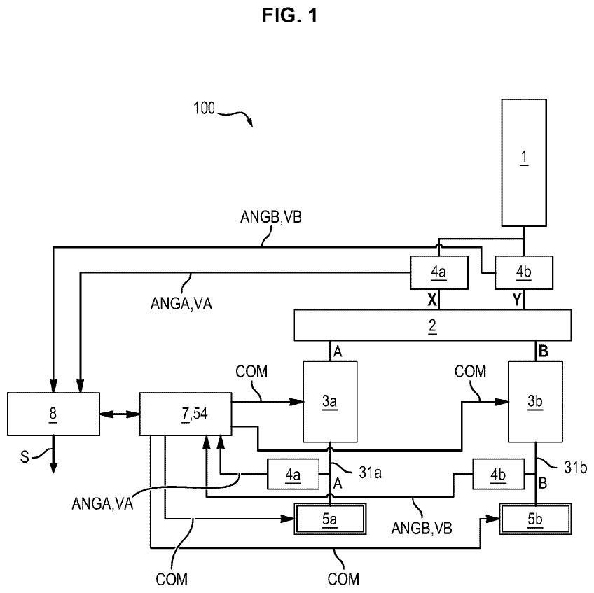

FIG. 1 shows a block diagram of the force application device for an aircraft control stick according to an embodiment of the invention.

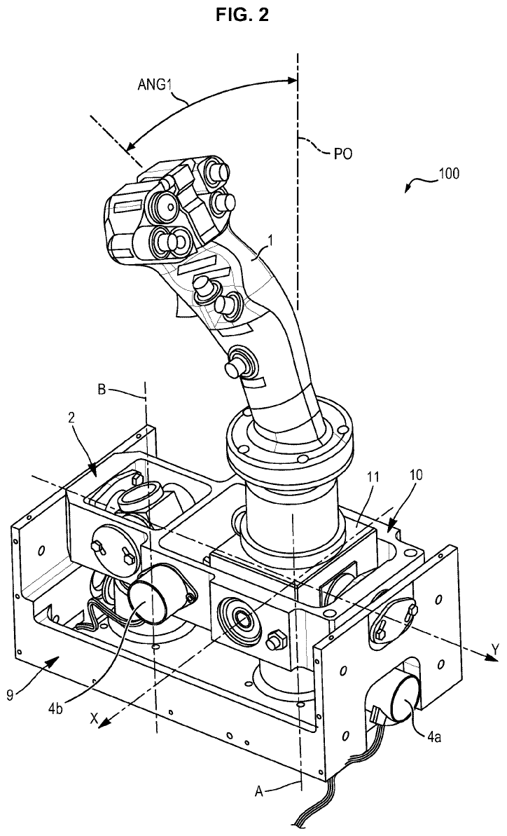

FIG. 2 shows a schematic perspective view of the force application device for an aircraft control stick according to an embodiment of the invention.

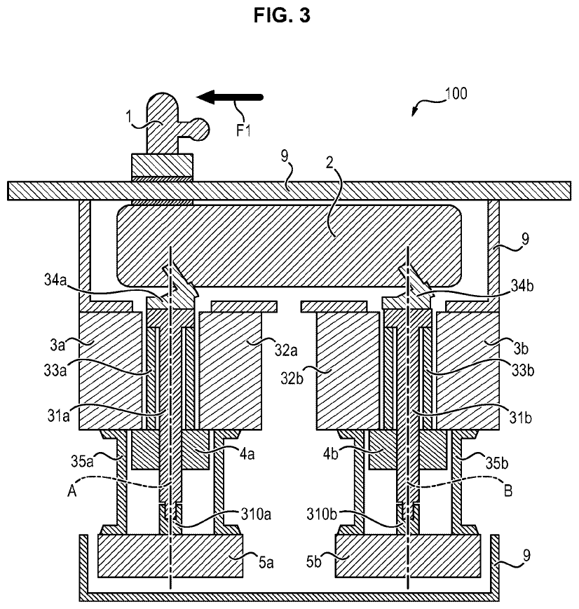

FIG. 3 shows a schematic axial section view of the force application device for an aircraft control stick according to an embodiment of the invention.

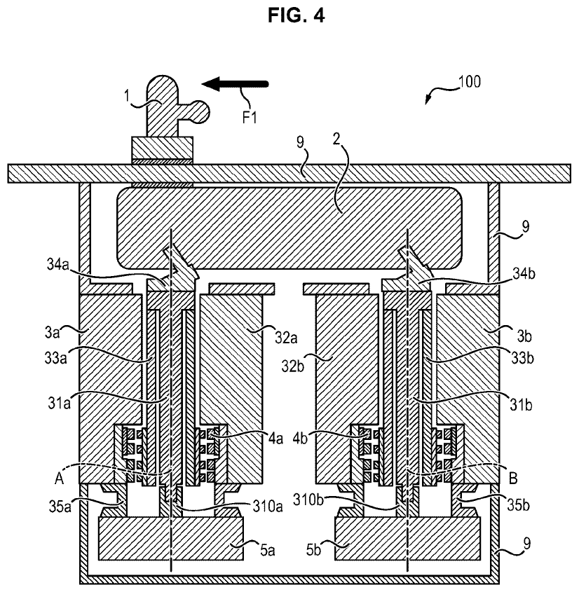

FIG. 4 shows a schematic axial section view of the force application device for an aircraft control stick according to an embodiment of the invention.

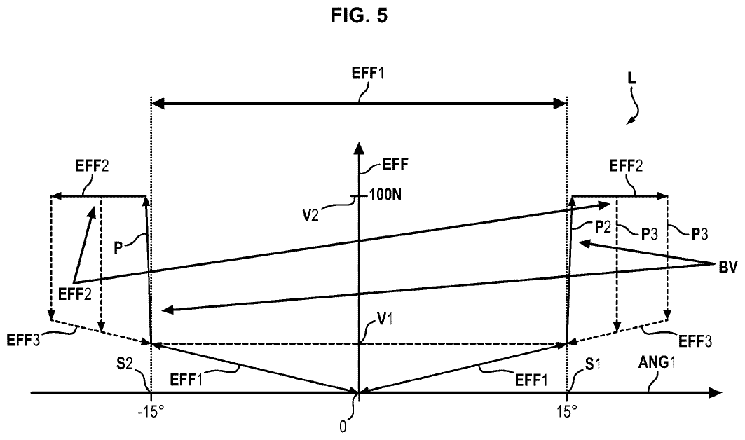

FIG. 5 shows a diagram of a law of force as a function of an angle of the lever of the force application device for an aircraft control stick according to an embodiment of the invention.

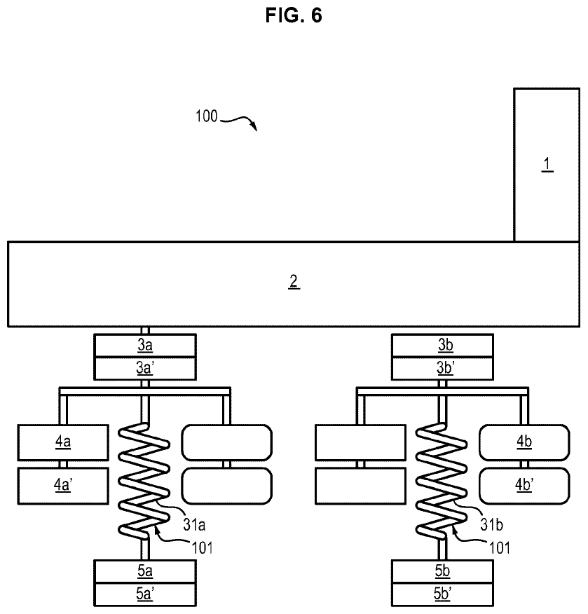

FIG. 6 shows a modular block diagram of the force application device for an aircraft control stick according to an embodiment of the invention.

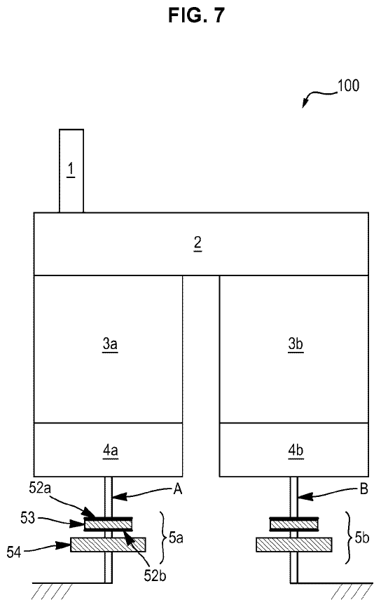

FIG. 7 shows a modular block diagram of the force application device for an aircraft control stick according to an embodiment of the invention.

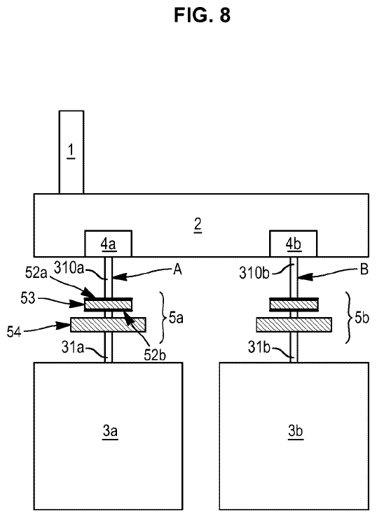

FIG. 8 shows a modular block diagram of the force application device for an aircraft control stick according to an embodiment of the invention.

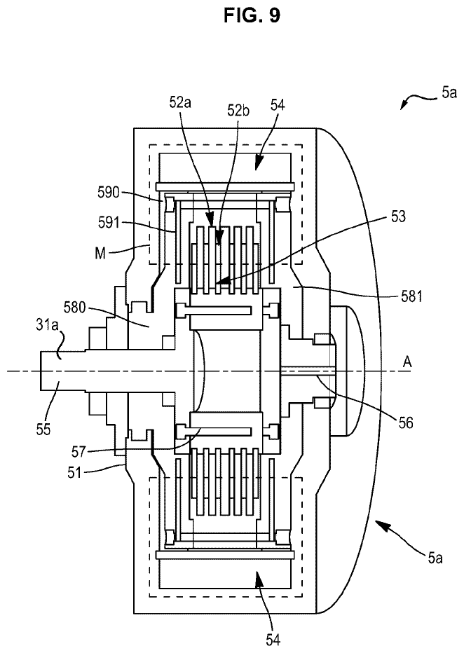

FIG. 9 shows a schematic section view of a brake of the force application device for an aircraft control stick according to an embodiment of the invention.

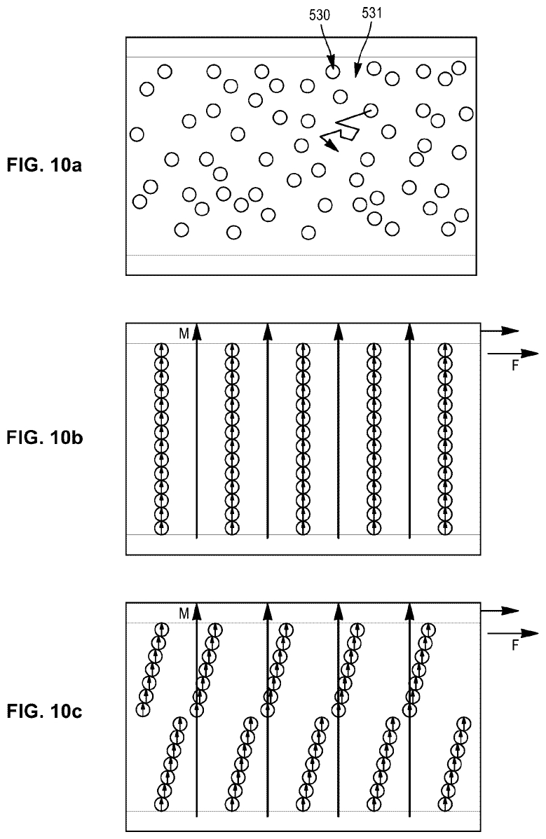

FIG. 10a shows an operating diagram of a magnetorheological brake of the force application device for an aircraft control stick according to an embodiment of the invention.

FIG. 10b shows an operating diagram of a magnetorheological brake of the force application device for an aircraft control stick according to an embodiment of the invention.

FIG. 10c shows an operating diagram of a magnetorheological brake of the force application device for an aircraft control stick according to an embodiment of the invention.

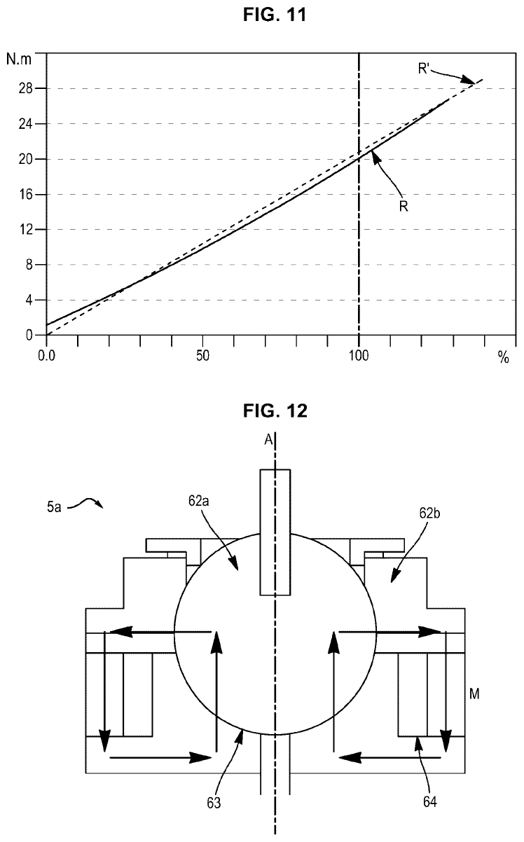

FIG. 11 shows a curve representative of a resistive torque exerted by the magnetorheological brake as a function of the current, in the force application device for an aircraft control stick according to an embodiment of the invention.

FIG. 12 shows a schematic section view of a variant of a brake of the force application device for an aircraft control stick according to an embodiment of the invention.

FIG. 13 shows a schematic section view of a variant of the brake of the force application device for an aircraft control stick according to an embodiment of the invention.

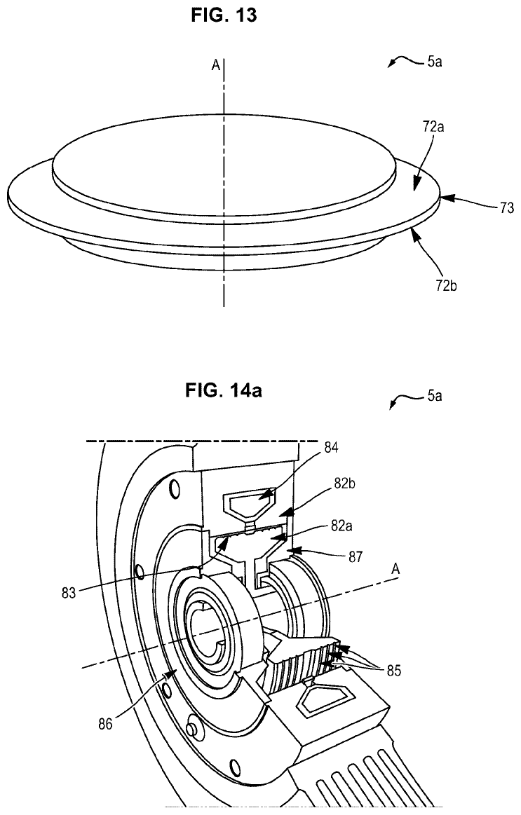

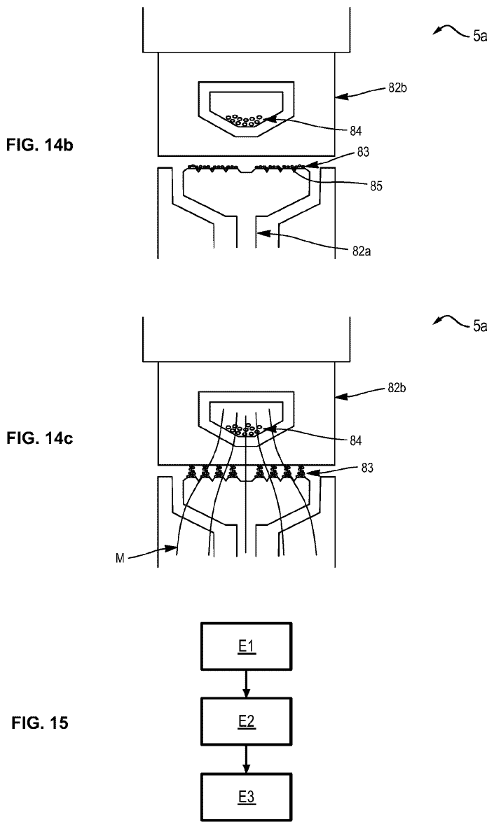

FIG. 14a shows a schematic section view of a variant of the brake of the force application device for an aircraft control stick according to an embodiment of the invention.

FIG. 14b is an operating diagram of a magnetic powder in the brake of FIG. 14a.

FIG. 14c is an operating diagram of a magnetic powder in the brake of FIG. 14a.

FIG. 15 is an organization diagram of a method of haptic feedback control of an aircraft control stick using the force application device according to an embodiment of the invention.

In the text that follows, examples are described of force application devices 100 on a lever 1 of an aircraft control mini-stick comprising at least one rheological brake, i.e. a brake comprising a volume configured to be filled with a rheological material. The rheological material can be magnetorheological in the case of a magnetorheological brake or an electrorheological material in the case of an electrorheological brake for example. The term “magnetorheological material” should be understood to mean a solid or liquid material, the shear resistance of which is variable as a function of an electromagnetic field which is applied to it, according to a predetermined characteristic (or rheogram). For example, the viscosity of the rheological material is variable as a function of the electromagnetic field. The term “electromagnetic field” is understood to mean a field which can be solely electrical, or else solely magnetic, or else comprise a magnetic component and an electrical component.

The device 100 can be provided on an aircraft control stick, such as for example an airplane or otherwise, and can be used to actuate all or part of the aircraft, such as for example an actuator, a cockpit actuator, flight controls, or another kind of control. The device 100 can be provided on a human-machine interface.

Moreover, the term “law of force” of the force application device 100 taken as a whole (rheological brake(s) and motor(s)) should be understood to mean the force, which can be resistive or driving, returned as a function of the position of the lever along the axis.

Similar components on the appended figures will be denoted by the same alphanumerical references throughout the description below.

FIG. 1 shows a functional architecture of a device 100 for controlling an aircraft about its axes of roll and pitch, particularly comprising a mini-control stick. The mini-stick is typically located in the aircraft cockpit.

The system comprises a control lever 1, which is attached to the stick and which is mounted rotatably on a mechanical joint 2 about a roll axis X or a pitch axis Y of the lever, the two axes being orthogonal. Preferably, the lever 1 is mounted on a plate 11 of the mechanical joint 2. The joint 2 is attached to a frame 9 secured to the aircraft cockpit floor. Of course, the control lever 1 could also be mounted rotatably on the mechanical joint 1 about the roll axis X only or about the pitch axis Y only.

First, there will be a description below of the components associated with the roll axis X, in the case where the control lever 1 is mounted rotatably on the mechanical joint 2 about the roll axis X, these components having reference signs ending by the letter “a” and being described as “first”.

The device 100 comprises a first force motor 3a for the roll axis X. The first force motor 3a has a first motor shaft 31a extending along a first direction A of actuation. The motor shaft 31a is linked to the roll axis X of the lever 1. The rotation of the motor shaft 31a about the first direction A of actuation is linked to the rotation of the mechanical joint 2 about the roll axis X. A linking mechanism exists between the motor shaft 31a and the joint 2 and is set in motion when the lever 1 pivots about the roll axis X. The force motor 3a is configured to exert a resistive torque on the motor shaft 31a. The motor shaft 31a can be attached to a first rotor 33a surrounded by a first fixed stator 32a of the motor 3a and is set in rotation with respect to the stator 32a. The device 100 comprises a first rheological (or magnetorheological) brake 5a able to apply a resistive force to the motor shaft 31a. The rheological brake 5a can be positioned directly on the first motor shaft 31a and/or on the roll axis X. The device 100 comprises a first measurement sensor 4a to measure at least one angular position and at least one sign of the velocity about the first motor shaft 31a and/or about the roll axis X.

Below is a description of the components associated with the pitch axis Y, in the case where the control lever 1 is mounted rotatably on the mechanical joint 2 about the pitch axis Y, these components having reference signs ending in the letter “b” and being described as “second”.

The device 100 comprises a second force motor 3b for the pitch axis Y. The second force motor 3b has a second motor shaft 31b extending about a second direction B of actuation. The motor shaft 31b is linked to the pitch axis Y of the lever 1. The rotation of the motor shaft 31b about the second direction B of actuation is linked to the rotation of the mechanical joint 2 about the pitch axis Y. A linking mechanism exists between the motor shaft 31b and the joint 2 and is set in motion when the lever 1 pivots about the pitch axis Y. The force motor 3b is configured to exert a resistive torque on the motor shaft 31b. The motor shaft 31b can be attached to a second rotor 33b surrounded by a second fixed stator 32b of the motor 3b and is set in rotation with respect to the stator 32b. The device 100 comprises a second rheological brake (or magnetorheological) brake 5b able to apply a resistive force to the motor shaft 31b. The rheological brake 5b can be positioned directly on the motor shaft 31b of the motor 3b and/or on the pitch axis Y. The device 100 comprises a second measurement sensor 4b to measure at least one angular position and at least one sign of the velocity about the second motor shaft 31b and/or about the pitch axis Y.

FIGS. 1, 2, 3, 4 and 6 to 8 show embodiments where both the roll axis X and the pitch axis Y, with the motors 3a and 3b, the sensors 4a and 4b and the brakes 5a and 5b respectively associated with the latter, are provided.

Of course, in another embodiment, not shown, the roll axis X associated with the first motor 3a, with the first sensor 4a and with the first brake 4a can be provided without the pitch axis Y, without the second motor 3b, without the second sensor 4b and without the second brake 4b.

Of course, in another embodiment, not shown, the pitch axis Y, associated with the second motor 3b, the second sensor 4b and the second brake 4b can be provided without the roll axis X, without the first motor 3a, without the first sensor 4a and without the first brake 4a.

FIG. 2 shows an exemplary embodiment. The lever 1 is arranged on the mechanical joint 2 attached to a frame 9 secured to a chassis of the aircraft. The motors 3a and/or 3b (not visible) are remote from the lever 1. The brake 5a and/or 5b is also remote from the lever 1. As indicated previously, the motor 3a and/or 3b and the brakes 5a and/or 5b are preferably vertically integrated under the mechanical joint 2.

The lever 1 is free at one end and is attached to a first plate 11 at the other end. The first plate 11 is rotationally movable about the axis X and about the axis Y and is linked to a second plate 10 of the joint 2. The axis X is linked to the first plate 11 such that a pivoting of the first plate 11 about the axis Y pivots the axis X about the axis Y. Two transmissions, each comprising a universal joint, convert a rotational movement of the lever 1 about the axis X, or about the axis Y respectively, into a movement of rotation of the motor shaft 31a (not shown) extending along the direction A, or of the motor shaft 31b (not shown) extending along the direction B respectively. The motor 3a and/or 3b is thus in direct engagement on the mechanical joint 2 and can transmit a resistive or motive force in response to the pivot movements of the lever 1 by the pilot. For more detail on the structure of the joint 2 and the mechanical link with the motors 3a and/or 3b, the reader may refer to FIG. 1 of the document FR-A-3 011 815 and the description pertaining thereto. This mechanical link may comprise an elbow shaft 34a located between the mechanical joint 2 and the shaft 31a and/or an elbow shaft 34b located between the mechanical joint 2 and the shaft 31b, as illustrated for example in FIGS. 3 and 4.

The term “directly position” should be understood to mean that the parts performing the braking (for example brake discs, as will be seen below) are arranged directly on the motor shaft. There are preferably no intermediate mechanical members between the parts performing the braking and the motor shaft. In particular, the brake 5a is directly aligned on the direction A of the motor shaft 31a. If the motor shaft 3a is vertically located under the lever 1, the brake 5a is preferably vertically incorporated on the motor shaft 31a. There is no angle return gear between the brake 5a and the motor shaft 31a. These considerations of alignment and incorporation are similarly applicable to the motor 3b and brake 5b components in relation to the shaft B and the motor shaft 31b.

The magnetorheological brake 5a and/or 5b comprises a control device configured to vary a magnetic field, said control device being electronically controlled by the control unit 8 via the calculator 7.

FIGS. 3, 4 and 7 show an architecture of the force application device 100 incorporated into the mini-stick according to a first embodiment. In this first embodiment, the motor 3a is located between the mechanical joint 2 and the brake 5a and/or the motor 3b is located between the mechanical joint 2 and the brake 5b.

According to the first embodiment shown in FIGS. 3 and 4 and at the bottom of FIG. 1, the sensor 4a measures an angular position ANGA and a sign of the velocity VA about the direction A of the motor shaft 31a of the motor 3a (and where applicable the velocity VA). The sensor 4a is located between the motor 3a and the brake 5a, leaving a non-zero length 310a of shaft 31a between the sensor 4a and the brake 5a. The sensor 4a can surround the shaft 31a and be located in an attachment part 35a attached between the fixed part of the brake 4a and the stator 32a.

According to the first embodiment shown in FIGS. 3 and 4 and at the bottom of FIG. 1, the sensor 4a measures an angular position ANGB and a sign of the velocity VB about the direction B of the motor shaft 31b of the motor 3b (and where applicable the velocity VB). The sensor 4b is located between the motor 3b and the brake 5b, leaving a non-zero length 310b of shaft 31b between the sensor 4b and the brake 5b. The sensor 4b can surround the shaft 31b and be located in an attachment part 35b attached between the fixed part of the brake 4b and the stator 32b.

The sensor 4a and/or 4b can be of inductive type, such as for example according to the embodiment shown in FIG. 4, where the sensor 4a and/or 4b is a resolver.

In another embodiment, the sensor 4a and/or 4b can be of resistive type (for example a potentiometer or another kind of sensor).

FIGS. 2 and 8 shown an architecture of the force application device 100 incorporated into the mini-stick according to a second embodiment. In this second embodiment, the brake 5a is located between the mechanical joint 2 and the motor 3a and/or the brake 5b is located between the mechanical joint 2 and the motor 3b.

According to the second embodiment shown in FIG. 2 and at the top of FIG. 1, the sensor 4a measures an angular position ANGX and a sign (or direction) of the velocity VX about the roll axis X (and where applicable the velocity VX) and is located in the mechanical joint 2.

According to the second embodiment shown in FIG. 2 and at the top of FIG. 1, the sensor 4b measures an angular position ANGY and a sign (or direction) of the velocity VY about the pitch axis Y (and where applicable the velocity VY) and is located in the mechanical joint 2.

The device 100 comprises a control calculator 7 for controlling the rheological brake 5a and/or 5b and the force motor 3a and/or 3b as a function of the angular position ANGX and/or ANGY and/or ANGA and/or ANGB and of the sign of the velocity VX and/or VY and/or VA and/or VB having been measured by the sensor 4a and/or 4b and sends them force application commands COM on the lever 1. The calculator 7 controls the force application device 100 for embodying the given force law L, described below. The calculator 7 comprises an electronic interface to receive the measurement signals of the sensor 4a and/or 4b. Provision can be made for other sensors, not shown, supplying the velocity measurements mentioned above to the calculator 7. The items of position and/or velocity information are translated into command signals S for controlling movable parts or actuators of the aircraft by a Flight Control System or FCS, which is connected to the calculator 7.

FIG. 5 illustrates an exemplary embodiment of the given force law L, produced by the calculator 7, with on the abscissa the angle ANG1 of the lever 1 and on the ordinate the forces EFF applied by the motor 3a and/or 3b and the brake 5a and/or 5b on the lever 1, the 0 indicating a zero angle ANG1 (corresponding to the neutral position P0) and a zero force EFF. The lever 1 has a neutral position P0. This neutral position P0 can correspond to a position around which the angle ANG1 of the lever 1 can vary in three dimensions around the axes X and Y, when the user's hand moves the lever 1. This neutral position P0 may correspond to a minimum or zero force exerted by the motor 3a and/or 3b and by the brake 5a and/or 5b on the lever 1 and can be a balance position of the lever 1. The calculator 7 can be configured to compute the angle ANG1 of the lever 1 with respect to the prescribed neutral position P0 as a function of the angular position ANGX and/or ANGY and/or ANGA and/or ANGB measured by the sensor 4a and/or 4b. Thus, to each angular position ANGX and/or ANGY and/or ANGA and/or ANGB corresponds an angle ANG1 of the lever 1 in three dimensions about the axes X and Y with respect to the neutral position P0. The calculator 7 can be configured to compute a direction of increase or decrease of the angle ANG1 of the lever 1 as a function of the sign of the velocity VX and/or VY and/or VA and/or VB having been measured by the sensor 4a and/or 4b.

According to a first case a) of this force law L, when the angle ANG1 of the lever 1 with respect to the prescribed neutral position P0 is in absolute value less than or equal to a non-zero prescribed virtual stop BV threshold S1 and/or S2, the calculator 7 sends a force command COM to the motor 3a and/or 3b, so that the motor 3a and/or 3b applies to the lever 1 a first resistive force EFF1 depending on the angle ANG1 of the lever 1, and sends a force command COM to the brake 5a and/or 5b to deactivate the brake 5a and/or 5b (which then applies a zero force to the shaft 31a and/or to the shaft 31b respectively). When the increasing angle ANG1 becomes equal to the prescribed virtual stop threshold S1 and/or S2, the first resistive force EFF1 has a first determined non-zero force value V1. The case a) embodies the normal displacement of the lever 1 by the hand of the user, to vary, in the manner desired by the user, the command signals S to control the movable parts or actuators of the aircraft by way of the flight control unit 8 using manual control. The sensor 4a and/or 4b for measuring the angular position ANGX and/or ANGY and/or ANGA and/or ANGB and the sign of the velocity VX and/or VY and/or VA and/or VB makes it possible to detect the intention of the user handling the lever 1 and wishing to decrease or increase the angle ANG1 of the lever 1 between 0 and the threshold S1 and/or S2 in this case a).

According to a second case b) of this force law L, when the angle ANG1 of the lever 1 with respect to the prescribed neutral position P0 is increasing in absolute value and exceeds the prescribed virtual stop threshold S1 and/or S2, the calculator 7 sends a force command COM to the motor 3a and/or 3b and to the brake 5a and/or 5b, so that the motor 3a and/or 3b and brake 5a and/or 5b apply to the lever 1 a second resistive force EFF2 greater than the first value V1. This makes the hand of the user touching the lever 1 feel a greater resistance (force return) in a fairly abrupt way on crossing of the threshold S1 and/or S2 in an increasing direction, which embodies a virtual stop of the lever 1. This virtual stop BV indicates that the angle ANG1 of the lever 1 has crossed the threshold S1 and/or S2 in the increasing direction, and can thus indicate that angle values ANG1 increasing above this threshold are not advised, or not authorized, or hazardous, or are reaching a limit, such as for example a flight envelope, or are a special command known to the user, or others. There is a steeper upward gradient P2 for passing from the value V1 to the second resistive force EFF2 than the gradient of the force EFF1 as a function of the angle ANG1. The sensor 4a and/or 4b for measuring the angular position ANGX and/or ANGY and/or ANGA and/or ANGB and the sign of the velocity VX and/or VY and/or VA and/or VB makes it possible to detect the intention of the user handling the lever 1 and wishing to increase the angle ANG1 above the threshold S1 and/or S2 in this case b).

According to a third case c) of this force law, when the angle ANG1 of the lever 1 with respect to the prescribed neutral position P0 is decreasing in absolute value while being greater than the prescribed virtual stop BV threshold S1 and/or S2, the calculator 7 sends a force command COM to the motor 3a and/or 3b, so that the motor 3a and/or 3b applies to the lever 1 a third return resistive force EFF3 dependent on the angle ANG1 of the lever 1, and sends a force command COM to the brake 5a and/or 5b to deactivate the brake 5a and/or 5b (which then applies a zero force to the shaft 31a and/or to the shaft 31b respectively). This makes the hand of the user touching the lever 1 feel a lesser resistance in a fairly abrupt way upon crossing of the threshold S1 and/or S2 in the decreasing direction, which embodies the cancellation of the virtual stop BV of the lever 1. In the example of FIG. 5, the third resistive force EFF3 is equal to the first determined value V1, non-zero, at the prescribed virtual stop threshold S1, S2 and is therefore continuous with the first force EFF1. There is a steeper downward gradient P3 to pass from the third resistive force EFF3 to the value V1 than the gradient of the force EFF1 as a function of the angle ANG1. The law L is then moved in case a). The sensor 4a and/or 4b for measuring the angular position ANGX and/or ANGY and/or ANGA and/or ANGB and the sign of the velocity VX and/or VY and/or VA and/or VB makes it possible to detect the intention of the user handling the lever 1 and wishing to decrease the angle ANG1 of the lever 1 below the threshold S1 and/or S2 in this case c). The brake 5a and/or 5b makes it possible to reduce the force to be supplied by the motor 3a and/or 3b, the brake 5a and/or 5b having a better resistive torque/electrical power consumption ratio than the motor 3a and/or 3b. The third return resistive force EFF3 is configured to bring the lever 1 into the prescribed neutral position P0 in the absence of any action of the hand of the user on the lever 1.

The arrows indicated in FIG. 5 therefore show a hysteresis of the force control law L in the direction of increase or decrease of the angle ANG1 of the lever 1.

The invention thus makes it possible to detect the intention of the user of the lever 1 of the stick without complicating the architecture of the device 100 and of the stick, and makes it possible to avoid adding subsystems or components to fulfil this function, in particular force and torque sensors. The invention provides a simplification of the architecture of the device 100, particularly for critical systems in an operational safety sense. The invention provides gains in functionality, bulk, weight, reliability and cost. The invention makes it possible to associate the intention of the user with micro-displacements (relative variations in position and velocity). The device according to the invention is non-intrusive and avoids a problem of incorporation of a sub-assembly such as for example a force sensor.

Thus, the principle of the invention is based on the elastic deformation of the transmission line of the device 100 exposed to forces (stress field) and going from the lever 1 to the brake 5a and/or 5b, and on the exploitation of items of position/velocity information already available in the system and initially provided for servo-control of the motor and brake. This item of information being relatively fine-grained and sensitive (>14 bits of resolution over 360°, making it possible to detect a very low-amplitude movement) and having a high bandwidth (>500 Hz) in relation to the use of the mini-stick by an operator (<50 Hz), it can be exploited to detect very small displacements and especially changes of sign of the displacement velocity of the lever 1, expressing the wish of the pilot to pull or push the stick. The sensors 4a, 4b can be positioned between the brake 5a and/or 5b and the lever 1 located at the interface with the hand of the user, with at least one elastically deformable part between the brake 5a and/or 5b and the sensor 4a and/or 4b. Thus, the intermediate parts 101 located between the brake 5a and/or 5b and the sensor 4a and/or 4b will constitute deformable components that will make it possible to observe a relative displacement on the transmission line. The torsion bar of the intermediate part 101 comprises the part of the motor shaft 31a and/or 31b (non-zero length 310a of shaft 31a and/or non-zero length 310b of shaft 31b) located between the sensor 4a and the brake 5a and/or between the sensor 4b and the brake 5b in the first embodiment of FIGS. 3, 4 and 7 and in the second embodiment of FIGS. 2 and 8.

FIG. 6 illustrates this principle of the architecture of the device 100 in the first embodiment of the FIGS. 3, 4 and 7. The intermediate part 101 schematizes a torsion bar allowing a transmission of torque between the lever 1 (via the mechanical joint 2) and the brake 5a and/or 5b, and an associated elastic deformation. When the brake 5a and/or 5b is activated, the force applied to the lever 1 by the hand of the user will be transmitted to the brake 5a and/or 5b via the torsion bar of the intermediate part 101. The objective is to make use of the items of position and relative velocity information in case c). Given that the brake 5a and/or 5b, when it has been activated in case b), holds the system in (mechanical) tension, the release of the lever 1 by the hand of the user will also give rise to a slight reduction in the angle ANG1 of the lever 1 that will be detected according to case c) and will cause the deactivation of the brake 5a and/or 5b. This will give rise to a return of the lever 1 toward its balance position P0 in case c) then a) owing to a residual torque applied by the motor 3a and/or 3b and can be detected by the sensor 4a and/or 4b. When the user wishes to see the stick return to the neutral position P0 (i.e. under the sole action of the motor 3a and/or 3b, or under the user's own action), the detected item of information about his intention releases the brake 5a and/or 5b and thus allows the return of the lever 1 to the neutral position P0. Without this detected item of intention information, the brake 5a and/or 5b will continue to be activated in case b), which will equate to having the sticked blocked in this area. The sensor 4a and/or 4b will thus detect the micro-displacement caused by the relaxation of force of the lever 1 by the hand of the user in case c), and the item of information about the sign of the velocity measured by the sensor 4a and/or 4b will make it possible to specify the direction of displacement of the lever 1 (direction of increase or decrease of the angle ANG1).

There can be a positive and non-zero prescribed virtual stop threshold S1 for the positive values of the angle ANG1 with respect to the prescribed neutral position P0, and a negative and non-zero prescribed virtual stop threshold S2 for the negative values of the angle ANG1 with respect to the prescribed neutral position P0. The threshold S1 can be equal in absolute value to the threshold S2, as shown by way of example in FIG. 5. In other embodiments not shown, the threshold S1 can be different from the threshold S2 in absolute value.

According to an embodiment shown in FIG. 6, the first force EFF1 may be linear and increasing as a function of the absolute value of the angle ANG1 and/or the third force EFF3 may be linear and increasing as a function of the absolute value of the angle ANG1.

According to another embodiment, not shown, the first force EFF1 may be curved and increasing as a function of the absolute value of the angle ANG1 and/or the third force EFF3 can be curved and increasing as a function of the absolute value of the angle ANG1.

Each motor 3a and/or 3b, each sensor 4a and/or 4b and each brake 5a and/or 5b can be doubled by another motor 3a′ and/or 3b′, another sensor 4a′ and/or 4b′ and another brake 5a′ and/or 5b′ respectively, as shown by the example in FIG. 6, to ensure redundancy and respond to operational safety considerations. The sensor 4a′ makes it possible to check whether or not the measurement of the sensor 4a is consistent. The sensor 4b′ makes it possible to check whether or not the measurement of the sensor 4b is consistent.

Following a test carried out on the following example of a torsion bar of the intermediate part 101, being a solid torsion shaft of a diameter of 10 mm, of length 100 mm, made of a material of 15-5 PH stainless steel type having a transverse elastic modulus of 77000 MPa, an elastic slip limit of 800 MPa and a failure limit of 1000 MPa, the torsional stress applied to this bar has been of 150.24 MPa exerted on the motor shaft at the brake, equivalent to approximate 200 N of force on the lever 1, with a safety coefficient of 1, a stress concentration coefficient of 2.95, a limit stress of 800 MPa, and the computed angular deformation of the bar has been of 0.758°. Thus, for a force of approximately 200N applied to the lever 1 and provided by the brake, the transmission shaft will deform by approximately 0.7°. Given the sensitivity on the position measurement of approximately 0.02° (14 bits over 360°), the position and velocity acquisition line will make it possible to detect this deformation and the movements imposed by the user on the associated lever.

According to an embodiment, the first resistive force EFF1 increases as a function of the angle ANG1 of the lever 1. Of course, the first resistive force EFF1 may not be monotonic as a function of the angle ANG1 of the lever 1 in other embodiments.

According to an embodiment, the third return force EFF3 increases as a function of the angle ANG1 of the lever 1. Of course, the third return force EFF3 may not be monotonic as a function of the angle ANG1 of the lever 1 in other embodiments.

According to an embodiment shown in FIG. 5, the second resistive force EFF2 is equal to a resistive force plateau V2, which is constant as a function of the angle ANG1 of the lever 1 with respect to the prescribed neutral position P0, when this angle ANG1 increases beyond the prescribed virtual stop threshold S1 and/or S2 in the case b).

According to an embodiment shown in FIG. 5, the second resistive force EFF2 is greater than or equal to 1.5 times or 2 times the first value V1, in particular greater than or equal to 50 N and less than or equal to 200 N. For example, the second resistive force EFF2 can be equal to 100 N.

According to an embodiment shown in FIG. 5, the prescribed virtual stop threshold S1 and/or S2 is greater than or equal to 5° and less than or equal to 45°. The threshold S1 and/or S2 can be limited by mechanical stops.

According to an embodiment shown in FIG. 5, the prescribed virtual stop threshold S1 and/or S2 is greater than or equal to 15° and less than or equal to 25° or to 20°.

In the remainder of the text there will be a description of embodiments of the magnetorheological brake 5a, the brake 5b being able to be of similar structure and operation to the brake 5a, with reference to FIGS. 7, 8, 9, 10a, 10b, 10c, 11, 12, 13, 14a, 14b and 14c.

An output shaft of the brake 5a extends directly along the direction A and is coaxial and attached to the shaft 31a of the motor 3a. The brake 5a comprises at least two first and second parts 52a and 52b facing one another and suitable for being set in motion with respect to one another. In this example, the parts 52a and 52b are suitable for rotating about the direction A. The term “facing” is understood to mean that at least one part of the outer surfaces of the two parts are face-to-face without being in contact. The brake 5a further comprises a volume 53 delimited by the two facing parts, suitable for housing magnetorheological fluid. The volume 53 is hermetically sealed so as not to let the magnetorheological fluid leak out. The term “volume delimited by two facing parts” should be understood to mean that the parts of the surfaces of the two parts which are located face-to-face are, at least partially and preferably totally, in contact with the volume of magnetorheological fluid.

An operating principle of the brake is to vary the shear resistance of the fluid contained in the volume 53, the two parts 52a and 52b shearing the fluid during their relative rotation about the direction A. The shear resistance torque exerted by the fluid is variable as a function of the magnetic field.

Preferably, the two parts 52a and 52b are located facing one other along the direction A of extension of the motor shaft 31a. The two parts shear the rheological fluid substantially perpendicularly to the direction A of the motor shaft 31a. To vary the shear resistance torque, and provide the control of the brake by the calculator 7, the brake comprises a commanding device or generator 54 configured to apply a variable magnetic field within the volume 53. This commanding or device or generator 54 is controlled by the calculator 7. The brake acts directly on the motor shaft 31a, with no intermediate mechanical members.

FIG. 9 gives a view of an embodiment of the magnetorheological brake 5a along a section view passing through the direction A. The brake comprises a chamber 51 of cylindrical shape and centered on the input shaft 55 extending along the direction A. The input shaft 55 corresponds to the motor shaft 31a of the motor 3a. The output shaft 56 of the brake is preferably coaxial with the input shaft 55. In this example the output shaft 56 is attached to the frame 9. Within the brake 5a, a plurality of brake discs are contained between a first sealed wall 580 and a second sealed wall 581. The brake comprises an alternation between a series of discs mounted on a rotor 57 secured to the input shaft 55, and a series of discs mounted securely on the output shaft 56. The brake discs are drilled at their centers and preferably centered on the direction A of the shaft 55. In particular, the brake comprises a disc 52a secured to the input shaft and a consecutive disc 52b secured to the output shaft. The discs 52a and 52b are here suitable for rotating with respect to one another about the direction A, upon rotation of the output shaft in relation to the input shaft. Preferably, the disc 52a is centered on the input shaft 55 and is therefore centered on the direction A. The disc 52b is preferably itself also centered on the direction A.

Between the faces of two consecutive brake discs, a sealing volume is provided suitable for receiving magnetorheological fluid in the liquid state. In particular, a volume 53 of fluid is delimited by the facing faces of the discs 52a and 52b. The sealing of each of the volumes is ensured by seals at spaces between the discs. The brake comprises an alternation of brake fiscs and volumes of magnetorheological fluid at different axial positions along the direction A. In this example, the volume of fluid between two consecutive disc faces is in contact with more than 50% of the surface of said faces.

According to an embodiment, the commanding or generating device 54 is disposed near volumes of fluid. Here, the commanding device or generator 54 is formed of two coils extending parallel to the direction A in the vicinity of the brake discs. The length of each of the coils is slightly greater than the total length over which the brake discs extend. According to a variant, the commanding device or generator 54 may further comprise a permanent magnet. FIG. 9 shows, in dotted lines, a field line M generated when a current circulates inside a coil 54. The magnetorheological fluid can be received inside the brake through filling channels not shown. The brake 5a can also comprise cooling channels 591 in the vicinity of the brake discs. Air can circulate in the chamber 51 through aeration ducts 590.

The behavior of the magnetorheological fluid of the volume 53 at rest and in the presence of a magnetic field is schematized in FIGS. 10a, 10b and 10c. A carrier fluid 531, preferably insulating, encloses a suspension of particles 530. Preferably, the particles are of a size between 1 and 10 microns. Metallic particles, for example iron, may be used as magnetic particles. At rest, the motion of the particles 530 is random, as shown by the arrow of FIG. 10a, and the particles do not exert any shear resistance. A residual shear resistance of the brake discs is exerted by the carrier fluid.

FIG. 10b shows the state of the system when a Lorentz force F is exerted on the particles 530 due to the magnetic field M. The particles 530 align in the form of particle chains parallel to the magnetic field lines, which increases the shear resistance of the magnetorheological fluid. The overall resistive torque of the magnetorheological fluid increases very significantly by comparison with the resistive torque of the carrier fluid alone. The parts 52a and 52b shear the fluid confined in the volume 53 when they rotate with respect to one another. When the shear resistance of the magnetorheological fluid increases, as in the state of FIG. 10b, the fluid generates a shear stress in the volume 53. The movements of the disc 52a and of the disc 52b are thus coupled. The resistive torque of all the volumes of fluid, taken together, may be sufficient to couple the input shaft 55 and the output shaft 56. If the output shaft is fixed, for example if it is attached to the frame 9 as in this example, the motor shaft is braked, or even locked, in its pivoting about the roll axis and/or pitch axis.

In FIG. 10c, the Lorentz force experienced by the particles 530 is increased due to the increase in the magnetic field. In FIG. 10c, a threshold of slip of the magnetorheological fluid has been exceeded; the particle chains are no longer able to align along the field lines, and drift in the direction of the force F, which can locally break. The resistive torque exerted on the lever remains substantially constant and a displacement occurs between the input and the output of the magnetorheological brake 5a. The shear resistance exerted by the magnetorheological fluid thus depends on the magnetic field, which is itself dependent on the current applied at the terminals of the coils.

FIG. 11 shows the relationship between intensity of the current at the coils (on the abscissa) and the resistive torque generated by the magnetorheological brake 5a (on the ordinate) according to an example. The brake is dimensioned to supply a resistive torque of 20 N.m in optimal operation at 100% of electric current. For a direct-current supply voltage of 36 V, the 100% of current corresponds to 0.5 mA. At 0%, there is a preloading of the brake with a torque of approximately 1 N.m. The torque then increases with the intensity of the current in a quasi-linear manner, according to the curve R. A linear approximation of the curve R is represented by the straight line R′.

The control of this brake 5a is simple since it is enough to control the current circulating at the terminals of the magnetic field controlling device to vary the resistive torque, within the limits of the fluid slip threshold.

FIG. 12 illustrates another example of a magnetorheological brake 5a which can be used. In this example, the rheological brake comprises a sphere 62a through the center of which the motor shaft 31a of the motor 3a passes, said shaft extending along the direction A. The brake 5a also comprises a spherical base 62b housing the sphere 62a. A movement of pivot of the lever 1 about the roll axis X causes a rotation of the shaft 31a about the direction A and a rotational movement of the sphere with respect to the base and/or a pivoting movement of the lever 1 about the pitch axis Y causes a rotation of the shaft 31b about the direction B and a rotational movement of the sphere with respect to the base. A bottom part of the sphere 62a, a top part of the base 62b and seals form the fluid volume 63. Coils 64 disposed in the vicinity of the volume 63 serve as a commanding device or generator 54 of the magnetic field. The coils are arranged such that the magnetic field lines M pass through a large surface of the sphere 62a. It is thus possible to control the shear resistance at the sphere 62a and, consequently, modulate the force feedback on the lever.

In a variant, a first shaft of a roll motor of the lever and a second shaft of a pitch motor of the lever both pass through the sphere 62a. If the magnetic field is sufficient, the brake thus exerts a force feedback along both the roll axis and the pitch axis.

Another alternative example of a magnetorheological brake 5a is illustrated in FIG. 13. In this example, the magnetorheological fluid is stressed in traction and/or in compression. The brake 5a comprises two discs 72a and 72b centered on the motor shaft 31a, the disc 72a being movable with respect to the disc 72b in translation along the direction A. In this example, the pivoting movement of the lever about the roll axis causes a translational movement of the disc 72a, a mechanical transmission mechanism connecting the shaft 31a to the lever 1. A volume of magnetorheological fluid is confined in a volume 73 between the two discs. A commanding device or generator 54, not shown in the figure, is suitable for generating a magnetic field substantially parallel to the direction A. When the magnetic field is less than the slip threshold, the resistance of the fluid to traction and compression along the direction A increases with the magnetic field, itself dependent on the current at the terminals of the control device. The examples of magnetorheological brakes of FIGS. 7 to 14c can be easily transposed to electrorheological brakes. In the case of the electrorheological brake, the rheological material is then an electrorheological fluid comprising conductive particles in suspension. The commanding device or generator 54 is then configured to apply a variable electric field in a volume of electrorheological fluid of the electrorheological brake.

For a use in an aircraft control mini-stick, the slip torque of the rheological material is preferably between 10 N.m and 100 N.m and still preferably between 10 N.m and 75 N.m. Specifically, the slip torque must be below a threshold torque determined by the maximum torque transmissible by a roll or pitch motor connected to the lever 1. Preferably, the brake 5a must be capable of returning a resistive force between 100 and 150 Newton, preferably of approximately 120 Newton, on the lever.

Another example of a rheological brake 5a is shown on FIG. 14a. Here it is a powder brake 5a. The rheological material used in this brake is a magnetic powder. This brake 5a is composed of two brake discs 86 and 87 whose gap is partially filled with a magnetic powder in a volume 83. The discs are centered on the direction A. The volume 83 is contained between an outer radial surface of the rotor 82a and an inner radial surface of the stator 82b. Said two surfaces extend substantially parallel to the direction A and face one another. When the rotor 82a rotates about the direction A with respect to the stator 82b, the rotor 82a shears the magnetic powder contained in the volume 83, in particular at the teeth 85 of the rotor. The teeth 85 correspond to channels dug in the outer radial surface of the rotor 82a. When the magnetic powder is not exposed to a magnetic field or is exposed to a negligible magnetic field, the magnetic powder is distributed under gravity in the gap and generates a low shear-resistant torque, by friction between the powder and the rotor, as illustrated for example in FIG. 14b. Conversely, when a magnetic field is applied to the volume 83, the powder contained in the volume 83 aligns along the field lines. Thus, the grains of powder create powder structures extending between the facing surfaces of the rotor 82a and stator 82b, as illustrated for example in FIG. 14c, these structures exerting a torque resistant to the shear exerted by the rotor 82a, the brake discs being thus coupled. The variable magnetic field is here exerted by two coils 84 electrically controlled by the calculator. The coils 84 are arranged in relation to the volume 83 such that the magnetic field lines are substantially perpendicular to the facing surfaces of the rotor 82a and stator 82b. The magnetic powder contained in dispersion in volume 83 constitutes a rheological material. The resistance of the magnetic powder to the shear exerted by the rotor depends on the magnetic field which is applied thereto, this field being electrically controllable. The greater the magnetic field exerted by the coils, the more the resistive force exerted by the magnetic powder increases. On the other hand, if a slip torque is exceeded at the powder brake, the resistive torque exerted by the magnetic powder of the volume 83 no longer increases with the magnetic field, and the brake discs are no longer correctly coupled.

The invention also relates to an active aircraft control stick, this stick comprising the force application device 100 described above and the lever 1 able to rotate about the roll axis X and about the pitch axis Y, the lever 1 being arranged on the mechanical joint 2.

The invention also relates to a method of haptic feedback control of the aircraft control stick using the force application device 100 described above.

In this method, during the step E1 illustrated in FIG. 15, a user exerts a tilt force F1 on the stick.

During step E2, in response to the tilt force F1 exerted by the user on the stick, the sensor 4a and/or 4b measures the angular position ANGX and/or ANGY and/or ANGA and/or ANGB and of the velocity VX and/or VY and/or VA and/or VB about the roll axis X and/or the pitch axis Y and/or the motor shaft 31a and/or 31b.

During step E3, the calculator 7 controls the rheological brake 5a and/or 5b and the motor shaft 3a and/or 3b as a function of the angular position ANGX and/or ANGY and/or ANGA and/or ANGB and of the sign of the velocity VX and/or VY and/or VA and/or VB having been measured by the sensor 4a and/or 4b, according to the cases a), b) and c) described above. The step E3 may comprise the following sub-steps, carried out by the calculator 7:
computing the angle ANG1 of the lever 1 with respect to the prescribed neutral position P0 as a function of the angular position ANGX and/or ANGY and/or ANGA and/or ANGB having been measured by the sensor 4a and/or 4b,
computing a direction of increase or decrease of the angle ANG1 of the lever 1 as a function of the sign of the velocity VX and/or VY and/or VA and/or VB having been measured by the sensor 4a and/or 4b.

The invention also relates to a computer program for implementing the control method described above, comprising code instructions, which when they are executed on the calculator 7, implement the following steps:
computing the angle ANG1 of the lever 1 with respect to the prescribed neutral position P0 as a function of the angular position ANGX and/or ANGY and/or ANGA and/or ANGB having been measured by the sensor 4a and/or 4b.
computing a direction of increase or decrease of the angle ANG1 of the lever 1 as a function of the sign of the velocity VX and/or VY and/or VA and/or VB having been measured by the sensor 4a and/or 4b,
generating the commands according to the cases a), b) and c) described above.

The computer program can be prerecorded on a permanent memory of the calculator 7. The calculator 7 can be or comprise one or more machines, one or more processors, one or more microprocessors, one or more random access memories, and one or more permanent memories. The calculator CAL may comprise one or more physical data input interfaces, and one or more physical data output interfaces. This physical data input interface or interfaces can be or comprise one or more physical data communication ports, or others. This physical data output interface or interfaces can be or comprise one or more physical data communication ports, or others. A computer program can be executed on the calculator 7 and comprise code instructions, which, when they are executed on this calculator, implement all or part of the method.

Of course, the embodiments, features, possibilities and examples described above can be combined with one another or be selected independently of one another.

1-16. (canceled)

17. A force application device for an aircraft control stick, the force application device comprising:
a mechanical joint configured to receive an aircraft control stick lever, the mechanical joint being rotationally movable about at least one axis from among a roll axis and a pitch axis,
at least one force motor comprising at least one motor shaft extending along at least one direction of actuation, a rotation of the at least one motor shaft about the at least one direction of actuation being linked to a rotation of the mechanical joint about the at least one axis, the at least one force motor being configured to exert a resistive torque on the at least one motor shaft,
at least one rheological brake configured to apply a resistive force to the at least one motor shaft,
at least one sensor that measures at least one angular position and at least one sign of a velocity about the at least one axis and/or about the at least one motor shaft, and
a calculator that controls the at least one rheological brake and the at least one force motor,
wherein the calculator is configured to control the at least one rheological brake and the at least one force motor as a function of the at least one angular position and of the at least one sign of the velocity having been measured by the at least one sensor, to:
when the at least one angular position corresponds to an angle of the aircraft control stick lever with respect to a prescribed neutral position, less than or equal in absolute value to a prescribed virtual stop threshold, control the at least one force motor to apply to the aircraft control stick lever a first resistive force as a function of the angle of the aircraft control stick lever and deactivate the at least one rheological brake, the first resistive force having a first determined value, which is non-zero at the prescribed virtual stop threshold,
when the at least one angular position corresponds to an angle of the aircraft control stick lever with respect to the prescribed neutral position, which increases in absolute value beyond the prescribed virtual stop threshold, control the at least one force motor and activate the at least one rheological brake to apply to the aircraft control stick lever a second resistive force greater than the first value, and
when the at least one angular position corresponds to an angle of the aircraft control stick lever with respect to the prescribed neutral position, which in absolute value decreases and is greater than the prescribed virtual stop threshold, control the at least one force motor to apply to the aircraft control stick lever a third return force as a function of the angle of the aircraft control stick lever and deactivate the at least one rheological brake.

18. The force application device as claimed in claim 17, wherein the first resistive force increases as a function of the angle of the aircraft control stick lever.

19. The force application device as claimed in claim 17, wherein the second resistive force is equal to a resistive force plateau, which is constant as a function of the angle of the aircraft control stick lever with respect to the prescribed neutral position, which increases beyond the prescribed virtual stop threshold.

20. The force application device as claimed in claim 17, wherein the third return force increases as a function of the angle of the aircraft control stick lever.

21. The force application device as claimed in claim 17, wherein the second resistive force is greater than or equal to 1.5 times the first value.

22. The force application device as claimed in claim 17, wherein the second resistive force is greater than or equal to 50 N and less than or equal to 200 N.

23. The force application device as claimed in claim 17, wherein the prescribed virtual stop threshold is greater than or equal to 5° and less than or equal to 45°.

24. The force application device as claimed in claim 17, wherein the third resistive force is equal to the first determined value, non-zero at the prescribed virtual stop threshold.

25. The force application device as claimed in claim 17, wherein the at least one rheological brake comprises a first part, a second part located facing the first part and a volume delimited by the first part and by the second part, the volume being suitable for containing a rheological material, the first part being arranged on the at least one motor shaft and being rotationally movable about the at least one direction of actuation with respect to the second part, and
the force application device comprises a generator, which is configured to apply a variable magnetic field within the volume to vary a shear resistance of the rheological material and which is controlled by the calculator.

26. The force application device as claimed in claim 17, wherein the calculator is configured to compute the angle of the aircraft control stick lever with respect to the prescribed neutral position as a function of the at least one angular position having been measured by the at least one sensor.

27. The force application device as claimed in claim 17, wherein the calculator is configured to compute a direction of increase or decrease of the angle of the aircraft control stick lever as a function of the at least one sign of the velocity having been measured by the at least one sensor.

28. The force application device as claimed in claim 17, wherein the at least one angular axis includes the roll axis and the pitch axis,
the at least one force motor includes a first force motor comprising a first motor shaft extending along at least a first direction of actuation and a second force motor comprising a second motor shaft extending along at least a second direction of actuation, the rotation of the first motor shaft about the first direction of actuation being linked to the rotation of the mechanical joint about the roll axis, the rotation of the second motor shaft about the second direction of actuation being linked to the rotation of the mechanical joint about the pitch axis,
the first force motor being configured to exert a first resistive torque on the first motor shaft, the second force motor being configured to exert a second resistive torque on the second motor shaft,
the at least one rheological brake includes a first rheological brake able to apply a resistive force to the first motor shaft and a second rheological brake, able to apply another resistive force to the second motor shaft, and
the at least one sensor includes a first sensor for measuring a first angular position and a sign of the velocity about the roll axis and/or about the first motor shaft, and a second sensor for measuring a second angular position and a sign of the velocity about the pitch axis and/or about the second motor shaft.

29. An active aircraft control stick comprising:
the force application device as claimed in claim 17, and
an aircraft control stick lever able to rotate about the at least one axis, the aircraft control stick lever being arranged on the mechanical joint.

30. A method of haptic feedback control of an aircraft control stick using the force application device as claimed in claim 17, the method comprising:
in response to a tilt force exerted by a user on the aircraft control stick, measuring, by the at least one sensor, the at least one angular position and the at least one sign of the velocity about the at least one axis and/or about the at least one motor shaft, and
controlling, by the calculator, the at least one rheological brake and the at least one force motor as a function of the at least one angular position and of the at least one sign of the velocity having been measured by the at least one sensor, to:
when the at least one angular position corresponds to an angle of the aircraft control stick lever with respect to a prescribed neutral position, less than or equal in absolute value to a prescribed virtual stop threshold, control the at least one force motor to apply to the aircraft control stick lever a first resistive force as a function of the angle of the aircraft control stick lever and deactivate the at least one rheological brake, the first resistive force having a first determined value, which is non-zero at the prescribed virtual stop threshold,
when the at least one angular position corresponds to an angle of the aircraft control stick lever with respect to the prescribed neutral position, which increases in absolute value beyond the prescribed virtual stop threshold, control the at least one force motor and activate the at least one rheological brake to apply to the aircraft control stick lever a second resistive force greater than the first value, and
when the at least one angular position corresponds to an angle of the aircraft control stick lever with respect to the prescribed neutral position, which in absolute value decreases and is greater than the prescribed virtual stop threshold, control the at least one force motor to apply to the aircraft control stick lever a third return force as a function of the angle of the aircraft control stick lever and deactivate the at least one rheological brake.

31. A computer program for implementing the method of haptic feedback control of an aircraft control stick as claimed in claim 30, the computer program comprising code instructions, which, when executed by the calculator, cause the calculator to at least:
compute the angle of the aircraft control stick lever with respect to the prescribed neutral position as a function of the at least one angular position having been measured by the at least one sensor,
compute a direction of increase or decrease of the angle of the aircraft control stick lever as a function of the at least one sign of the velocity having been measured by the at least one sensor,
when the angle of the aircraft control stick lever with respect to its prescribed neutral position is in absolute value less than or equal to the prescribed virtual stop threshold, control the at least one force motor to apply to the aircraft control stick lever a first resistive force as a function of the angle of the aircraft control stick lever and deactivating the at least one rheological brake, the first resistive force having a first determined value, which is non-zero at the prescribed virtual stop threshold,
when the angle of the aircraft control stick lever with respect to its prescribed neutral position increases in absolute value beyond the prescribed virtual stop threshold, control the at least one force motor and activating the at least one rheological brake to make them apply to the aircraft control stick lever a second resistive force greater than the first value, and
when the angle of the aircraft control stick lever with respect to its prescribed neutral position in absolute value decreases and is greater than the prescribed virtual stop threshold, control the at least one force motor to apply to the aircraft control stick lever a third return force as a function of the angle of the aircraft control stick lever and deactivating the at least one rheological brake.

32. An aircraft comprising the active aircraft control stick as claimed in claim 29.
